(19) United States
(12) Patent Application Publication
(10) Pub. No.: US 2025/0192223 A1
(43) Pub. Date: Jun. 12, 2025

(54) SYNTHESIS OF AL-DOPED LLZO THIN-TAPE ELECTROLYTES FOR SOLID-STATE BATTERIES USING FLAME-ASSISTED SPRAY PYROLYSIS

(71) Applicant: Massachusetts Institute of Technology, Cambridge, MA (US)

(72) Inventors: Sili Deng, Newton, MA (US); Valerie L. Muldoon, Cambridge, MA (US); Jianan Zhang, Cambridge, MA (US)

(21) Appl. No.: 18/843,932

(22) PCT Filed: Mar. 1, 2023
(86) PCT No.: PCT/US2023/063445

§ 371 Date: Sep. 4, 2024

Related U.S. Application Data
(60) Provisional application No. 63/317,137, filed on Mar. 7, 2022.

(51) Int. Cl. H01M 10/0562; C23C 4/11; C23C 4/129

(52) U.S. Cl. CPC H01M 10/0562; C23C 4/11; C23C 4/129; H01M 2300/0071

(57) ABSTRACT

A method of synthesis of aluminum-doped Li_{6.25}Al_{0.25}La₃Zr₂O₁₂ (Al-LLZO) can include preparing a precursor solution by dissolving lithium nitrate, aluminum nitrate, zirconium (IV) oxynitrate, and lanthanum nitrate in stoichiometric amounts according to the composition Li_{6.25}Al_{0.25}La₃Zr₂O₁₂ in water, and decomposing droplets by passing through a co-flow burner. Also disclosed is a method of produce producing a thin-tape comprising Al-LLZO.

### CLAIM OF PRIORITY

This application claims priority to U.S. Provisional Patent Application No. 63/317,137, filed Mar. 7, 2022, which is incorporated by reference in its entirety.

### FIELD OF THE INVENTION

The invention relates to synthesis of materials using flame-assisted spray pyrolysis.

### BACKGROUND

As demands for energy storage options with improved safety and energy density increase, all-solid-state batteries have become a promising option for many applications due to the elimination of the flammable liquid electrolyte. Of the various chemistries being considered for solid-state electrolytes (SSEs), oxide-based SSEs are advantageous due to their exceptional electrochemical stability against many electrode materials. However, they can suffer from relatively low ionic conductivities, thereby necessitating the use of a thin, dense tape to ensure good rate performance. Many current methods used to synthesize oxides are either too expensive and complex or produce powders that require many post-processing steps and long, high-temperature heat treatments to ensure a dense SSE.

### SUMMARY

This Summary introduces a selection of concepts in simplified form that are described further below in the Description. This Summary neither identifies key or essential features, nor limits the scope, of the claimed subject matter.

In one aspect, a method of synthesis of aluminum-doped lithium lanthanum zirconate oxide can include forming droplets of a precursor solution including a lithium salt, an aluminum salt, a zirconium salt, and a lanthanum nitrate in stoichiometric amounts to form an aluminum-doped lithium lanthanum zirconate oxide in a stream of air, preheating the droplets, generating a flame in a burner, decomposing the droplets by passing through the burner, depositing as synthesized particles (ASP) on a powder collector, and heating the ASP in a furnace in the presence of an oxidizing agent to produce the aluminum-doped lithium lanthanum zirconate oxide.

In another aspect, a method of synthesis of aluminum-doped lithium lanthanum zirconate oxide can include:
preparing a precursor solution by dissolving lithium nitrate, aluminum nitrate, zirconium (IV) oxynitrate, and lanthanum nitrate in stoichiometric amounts to form lithium lanthanum zirconate oxide in water;
aerosolizing the precursor solution in a stream of air using an ultrasonic nebulizer to form droplets;
preheating the droplets;
generating a flame in a burner;
decomposing the droplets by passing through the burner;
depositing as synthesized particles (ASP) on a powder collector; and
heating the ASP in a furnace in the presence of an oxidizing agent to produce the aluminum-doped lithium lanthanum zirconate oxide.

In certain circumstances, the lithium salt of the precursor solution can be in greater than 10 wt % excess of the stoichiometric amounts to form the aluminum-doped lithium lanthanum zirconate oxide, greater than 20 wt % excess of the stoichiometric amounts to form the aluminum-doped lithium lanthanum zirconate oxide, or greater than 30 wt % excess of the stoichiometric amounts to form the aluminum-doped lithium lanthanum zirconate oxide.

In certain circumstances, the method can include adding 30 wt % excess LiNO₃ to the precursor solution.

In certain circumstances, the aluminum nitrate of the precursor solution can be aluminum nitrate nonahydrate (Al(NO₃)₃·9H₂O).

In certain circumstances, the zirconium (IV) oxynitrate of the precursor solution can be zirconium (IV) oxynitrate hydrate (ZrO(NO₃)₂·6H₂O).

In certain circumstances, the aluminum-doped lithium lanthanum zirconate oxide can be aluminum-doped Li_{6.25}Al_{0.25}La₃Zr₂O₁₂.

In certain circumstances, the method can include maintaining metal salt concentration in the precursor solution at 1 mol/L.

In certain circumstances, the droplets can be passed through the burner at a flow rate of 5 L/min to 10 L/min.

In certain circumstances, the method can include passing the droplets through the co-flow burner at a flow rate of 10 L/min.

In certain circumstances, the powder collector can be a glass-fiber filter.

In certain circumstances, the preheating of the droplets can include passing the droplets through three low-temperature preheating zones.

In certain circumstances, the method can include maintaining the three preheating zones at in a temperature gradient of 10° C. to 20° C. between each preheating zone. The temperature of the first preheating zone can be between 120° C. and 170° C. The temperature of the second preheating zone can be between 130° C. and 190° C. The temperature of the third preheating zone can be between 140° C. and 210° C.

In certain circumstances, the preheating of the aerosolized droplets can include heating by passage through three low-temperature preheating zones.

In certain circumstances, the method can include maintaining the three preheating zones at 160° C., 170° C., and 190° C., respectively.

In certain circumstances, the mixture of methane and air can use premixed methane and air at 20 L/min and 1.33 L/min, respectively.

In certain circumstances, a method of forming a tape can include
collecting the aluminum-doped lithium lanthanum zirconate oxide from the filter;
pressing the aluminum-doped lithium lanthanum zirconate oxide;
heating the pressed aluminum-doped lithium lanthanum zirconate oxide in a tube furnace;
cooling the aluminum-doped lithium lanthanum zirconate oxide to room temperature;
grinding the aluminum-doped lithium lanthanum zirconate oxide to an aluminum-doped lithium lanthanum zirconate oxide powder;
preparing a slurry mixture of poly(acrylic) acid, ethanol, the aluminum-doped lithium lanthanum zirconate oxide powder, benzyl butyl phthalate, polyvinyl butyral, and yttria stabilized zirconia milling media;
tape casting the slurry mixture on a polyester substrate;
drying the tape; and
heating the tape.

In certain circumstances, the method can include pressing the ASP prior to heating the ASP in a furnace in the presence of an oxidizing agent to produce the aluminum-doped lithium lanthanum zirconate oxide. For example, the pressure can be between 200 and 700 MPa.

In certain circumstances, heating the ASP in a furnace in the presence of an oxidizing agent can be at a temperature of greater than 650° C.

In certain circumstances, the oxidizing agent can include oxygen or oxygen mixed with an inert gas.

In certain circumstances, the method can include pressing the ASP at 433 MPa.

In certain circumstances, the method can include placing the ASP in a tube furnace with oxygen flowing at 0.25 L/min, heating at 5° C./min to 650° C., and holding the ASP at 650° C. for 3 hours.

In certain circumstances, the method can include grinding the ASP in a mortar and pestle to an Al-LLZO powder.

In certain circumstances, the method can include tape casting the slurry mixture on a polyester substrate with a doctor blade.

In certain circumstances, the method can include drying the tape completely and hot-pressing the dried tape at 500 MPa and 100° C. for 15 minutes.

In certain circumstances, the method can include placing green tapes between alumina substrates in an oxygen atmosphere flowing at 0.25 L/min.

In certain circumstances, the method can include heating tape samples at 5° C./min to 300° C./2 hr.

In certain circumstances, the method can include heating tape samples at 5° C./min to 700° C./2 hr.

In certain circumstances, the method can include heating tape samples at 2° C./min to 1200° C./2 hr.

In certain circumstances, the ultrasonic sprayer can be a 1.7 MHz ultrasonic sprayer.

In another aspect, an aluminum-doped lithium lanthanum zirconate oxide can include a fully crystalline cubic aluminum-doped lithium lanthanum zirconate oxide having a grain size of less than 1 micron.

In another aspect, a solid state electrolyte can an aluminum-doped lithium lanthanum zirconate oxide produced by the methods described herein.

In another aspect, a solid state battery can include the solid state electrolyte described herein.

The following Description references the accompanying drawings which form a part this application, and which show, by way of illustration, specific example implementations. Other implementations may be made without departing from the scope of the disclosure.

### BRIEF DESCRIPTION OF THE DRAWINGS

FIG. 1 is a schematic illustration of the flame-assisted spray pyrolysis (FASP) setup.

FIGS. 2A-2F are SEM images of (FIG. 2A) ASP-LFR, (FIG. 2B) ASP-MFR, (FIG. 2C) ASP-HFR, (FIG. 2D) D-LFR, (FIG. 2E) D-MFR, and (FIG. 2F) D-HFR samples.

FIGS. 3A-3B are XRD plots of (FIG. 3A) as-synthesized powder samples and (FIG. 3B) decomposed powder samples.

FIG. 4 is a graph depicting TGA data showing weight loss of ASP and decomposed powder.

FIGS. 5A-5F are SEM images of the fracture surface of sintered tapes made with (FIG. 5A) ASP-LFR, (FIG. 5B) ASP-MFR, (FIG. 5C) ASP-HFR, (FIG. 5D) D-LFR, (FIG. 5E) D-MFR, and (FIG. 5F) D-HFR samples.

### DESCRIPTION

Reference numbers in parenthesis “(Ref.)” herein refer to the corresponding literature listed in the attached Bibliography which forms a part of this Specification, and the literature is incorporated by reference herein.

An inexpensive, scalable method, using flame-assisted spray pyrolysis (FASP) can produce loosely agglomerated particles with controlled morphology and can be combined with conventional tape casting to produce oxide-based, thin-tape solid-state electrolytes (SSEs). This method is shown herein to be used to successfully synthesize Al-doped LLZO (Li_{6.25}Al_{0.25}La₃Zr₂O₁₂), which is known as a very promising solid electrolyte due to its impressive electrochemical stability and relatively high ionic conductivity. The effect of FASP parameters on the as-synthesized Al-doped LLZO powder and on the quality of thin-tapes are described herein. The results show that FASP parameters can be tailored to produce high-quality thin-tape solid-state electrolytes for use in solid-state batteries.

As global decarbonization becomes increasingly important, the demand for energy and power dense energy storage technologies is rising. Current lithium-ion battery technologies are reaching their performance limits due the use of a flammable liquid electrolyte and electrode materials with limited capacities (Ref. 1). By employing SSEs, solid-state batteries can use high-voltage cathode materials and a lithium metal anode, thereby significantly increasing power and energy densities and improving safety, which are crucial features for application in electric vehicles and distributed energy storage systems (Ref. 5).

For solid-state batteries to be commercially viable, SSEs must be around 25 μm thick (Ref. 6) but achieving this form factor is a significant manufacturing challenge. Vapor deposition techniques have been employed to synthesize thin-films, but these methods are energy and time intensive (Ref. 7). Alternatively, solid-state reactions are used in literature to synthesize metal-oxides for SSEs, but these powders are suboptimal for conventional tape-casting, thereby necessitating many post-processing steps and long, high-temperature heat treatments (Ref. 7). While other works use wet-chemical methods such as sol-gel to synthesize SSE powders, these methods are typically complex and difficult to scale (Refs. 6 and 8).

Flame-assisted spray pyrolysis (FASP) was employed to synthesize Al-doped LLZO (Al-LLZO), a promising oxide-based SSE with a relatively high ionic conductivity and good electrochemical stability (Ref. 8). Spray-based methods are known to be particularly suitable for synthesizing Al-LLZO(Ref. 8). As a result, Al-LLZO powders synthesized with spray methods require shorter calcination and sintering treatments (Ref. 8), and often these powders can form Al-LLZO at lower temperatures than powders produced with other methods (Ref. 9).

A FASP setup was used to synthesize Al-LLZO powders suitable for tape-casting. FASP parameters affect powder characteristics, allowing tailoring of the process to produce powders that can be used to fabricate thin-tape SSEs in a scalable way.

A method of synthesis of aluminum-doped lithium lanthanum zirconate oxide can include forming droplets of a precursor solution including a lithium salt, an aluminum salt, a zirconium salt, and a lanthanum nitrate in stoichiometric amounts to form an aluminum-doped lithium lanthanum zirconate oxide in a stream of air, preheating the droplets, generating a flame in a burner, decomposing the droplets by passing through the burner, depositing as synthesized particles (ASP) on a powder collector, and heating the ASP in a furnace in the presence of an oxidizing agent to produce the aluminum-doped lithium lanthanum zirconate oxide.

The lithium salt can be lithium nitrate, lithium hydroxide, lithium carbonate, or lithium sulfate, or a mixture thereof. The aluminum salt can be aluminum nitrate, aluminum hydroxide, aluminum carbonate, or aluminum sulfate, or a mixture thereof. The zirconium salt can be zirconium nitrate, zirconium oxynitrate, zirconium hydroxide, zirconium carbonate, or zirconium sulfate, or a mixture thereof. The lanthanum salt can be lanthanum nitrate, lanthanum hydroxide, lanthanum carbonate, or lanthanum sulfate, or a mixture thereof.

In certain circumstances, the lithium salt of the precursor solution can be in greater than 10 wt % excess of the stoichiometric amounts to form the aluminum-doped lithium lanthanum zirconate oxide, greater than 20 wt % excess of the stoichiometric amounts to form the aluminum-doped lithium lanthanum zirconate oxide, or greater than 30 wt % excess of the stoichiometric amounts to form the aluminum-doped lithium lanthanum zirconate oxide.

In certain circumstances, the aluminum-doped lithium lanthanum zirconate oxide can have a formula Li_{6.25}Al_{0.25}La₃Zr₂O₁₂.

In certain circumstances, the droplets can be passed through the burner at a flow rate of 5 L/min to 10 L/min, for example, 5 L/min, 6 L/min, 7 L/min, 8 L/min, 9 L/min, or 10 L/min. As flow rate increases, amorphous content decreases, resulting in fully crystalline powders.

In certain circumstances, the preheating of the droplets can include passing the droplets through three low-temperature preheating zones. The threes preheating zones can have a temperature gradient of 10° C. to 20° C. between each preheating zone. For example, the temperature difference between the first preheating zone and the second preheating zone can be 10° C. and the difference between the second preheating zone and the third preheating zone can be 20° C. The temperature of the first preheating zone can be between 120° C. and 170° C. The temperature of the second preheating zone can be between 130° C. and 190° C. The temperature of the third preheating zone can be between 140° C. and 210° C. In certain circumstances, the first preheating zone can be 120° C., 130° C., 140° C., 150° C., 160° C., or 170° C. In certain circumstances, the second preheating zone can be 130° C., 140° C., 150° C., 160° C., 170° C., 180° C., or 190° C. In certain circumstances, the third preheating zone can be 140° C., 150° C., 160° C., 170° C., 180° C., 190° C., 200° C., or 210° C.

In certain circumstances, the method can include pressing the ASP prior to heating the ASP in a furnace in the presence of an oxidizing agent to produce the aluminum-doped lithium lanthanum zirconate oxide. The pressure can be 200 MPa, 300 MPa, 400 MPa, 500 MPa, 600 MPa, or 700 MPa. For example, the pressure can be between 200 and 700 MPa.

In certain circumstances, heating the ASP in a furnace in the presence of an oxidizing agent can be at a temperature of greater than 500° C., greater than 550° C., greater than 600° C., greater than 650° C., greater than 700° C., or greater than 750° C. The temperature can be less than 1200° C., less than 1100° C., less than 1000° C., less than 900° C., less than 850° C., or less than 800° C. The heating can be for greater than 10 minutes, greater than 20 minutes, greater than 30 minutes, greater than 40 minutes, greater than 50 minutes, greater than 60 minutes, greater than 70 minutes, greater than 80 minutes, greater than 90 minutes, greater than 2 hours, greater than 3 hours, greater than 4 hours, greater than 5 hours, or greater than 6 hours. The heating can be for be less than 10 hours, less than 9 hours, less than 8 hours, less than 7 hours, or less than 6 hours.

In certain circumstances, the oxidizing agent can include oxygen or oxygen mixed with an inert gas.

A tape can be prepared from a powder. The tape can be cast from a slurry mixture of a binder and the aluminum-doped lithium lanthanum zirconate oxide powder. The binder can include a polymer such as poly(acrylic) acid, poly(methacrylic) acid, polyvinyl butyral, polyvinyl alcohol, polystyrene, a polyolefin, or mixtures thereof.

The tape can be a green tape formed by casting and pressing the slurry. The pressing can be at a pressure of 200 MPa, 300 MPa, 400 MPa, 500 MPa, 600 MPa, or 700 MPa. For example, the pressure can be between 200 and 700 MPa. The green tape can be heated to dry the composition, for example, at 80° C., 90° C., 100° C., 110° C., 120° C., 130° C., 140° C., 150° C., 160° C., 170° C., 180° C., 190° C., or 200° C. The tape can be sintered at a temperature of less than 1100° C.

An aluminum-doped lithium lanthanum zirconate oxide can include a fully crystalline cubic aluminum-doped lithium lanthanum zirconate oxide having a grain size of less than 1 micron. For example, the aluminum-doped lithium lanthanum zirconate oxide can be a cubic-phase of Al-LLZO The aluminum-doped lithium lanthanum zirconate oxide can include micron-scale spherical particles and nano-scale particles that agglomerate together to form clusters and coat the surface of larger particles. The particles can be porous.

A solid state electrolyte can an aluminum-doped lithium lanthanum zirconate oxide produced by the methods described herein.

A solid state battery can include the solid state electrolyte described herein.

### EXAMPLES

### Precursor Solution Preparation

Lithium nitrate (LiNO₃), aluminum nitrate nonahydrate (Al(NO₃)₃·9H₂O), zirconium (IV) oxynitrate hydrate (ZrO(NO₃)₂·6H₂O), and lanthanum (III) nitrate hexahydrate (La(NO₃)₃·6H₂O) are dissolved in deionized water in stoichiometric amounts according to the nominal composition Li_{6.25}Al_{0.25}La₃Zr₂O₁₂. To compensate for expected lithium volatilization during the FASP process and high temperature sintering, an additional 30 wt % of LiNO₃ is added. The metal salt concentration in the precursor solution is maintained at 1 mol/L across all experiments. The precursor solution detailed here is specifically for synthesizing Al-LLZO, but the various metal salts can be changed to synthesize other oxide-based materials.

### Material Synthesis Via FASP

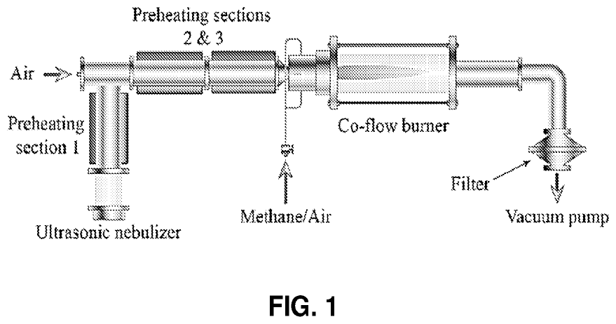

A schematic of the FASP experimental setup is shown in FIG. 1. The setup consists of a 1.7 MHz ultrasonic nebulizer, three preheating zones, a co-flow burner, and a glass fiber filter. The ultrasonic nebulizer creates a fine mist of droplets, which are transported through three preheating zones by air flowing at 10 L/min. The first, second, and third preheating sections are maintained at 160° C., 170° C., and 190° C., respectively, throughout all trials. The partially-dried particles are then carried through the co-flow burner, which used premixed methane and air with various flow rates depending on which trial was being conducted. Specific values of air and methane flow rates can be found in Table 1. The dried particles were deposited on the filter, where the as-synthesized powder (ASP) is collected after each trial.

TABLE 1
Flow rates used for various trials.

| | Air | Methane | | Decomposed |
|---|---|---|---|---|
| FASP Condition | (LPM) | (LPM) | ASP Name | Name |
| Low flow rate | 15 | 1.00 | ASP-LFR | D-LFR |
| Medium flow rate | 20 | 1.33 | ASP-MFR | D-MFR |
| High flow rate | 30 | 2.00 | ASP-HFR | D-HFR |

For each ASP sample collected, half of the powder was used to synthesize slurries for making thin-tapes and the other half was heat-treated to decompose the powder. ASP samples were pressed at 433 MPa. The resulting pellets were subsequently placed in a tube furnace with oxygen flowing at 0.25 L/min and heated at 5° C./min to 650° C., where they were held for 3 hours. After naturally cooling to room temperature, the samples were ground using a mortar and pestle.

### Slurry and Tape Preparation

Poly(acrylic) acid, ethanol, Al-LLZO powder, benzyl butyl phthalate, polyvinyl butyral, and yttria stabilized zirconia milling media were mixed using a planetary centrifugal mixer. The resulting slurry was tape cast on a polyester substrate with a doctor blade. After drying completely, tapes were hot-pressed at 500 MPa and 100° C. for 15 minutes to ensure good packing density. Green tapes were then placed in between alumina substrates in an oxygen atmosphere flowing at 0.25 L/min. Samples were ramped at 5° C./min to 300° C./2 hr, ramped at 5° C./min to 700° C./2 hr, and finished by ramping at 2° C./min to 1200° C./2 hr. Low temperature holds are employed to allow for gentle binder burnout and prevent cracking of tapes, and 1200° C. was chosen as the final sintering temperature to promote densification of the material.

### Characterization Methods

Scanning electron microscopy (SEM) images were taken with a Zeiss Merlin high-resolution scanning electron microscope to investigate morphology of samples. X-ray diffraction (XRD) was employed to determine crystallinity using the PANalytical X′Pert PRO X-ray diffractometer with Cu Kα radiation (K_{α1}=1.540598 Å and K_{α2}=1.544426 Å) from 10-80° 20. Thermogravimetric analysis (TGA) was conducted in an air environment from 30-900° C. at 5° C./min.

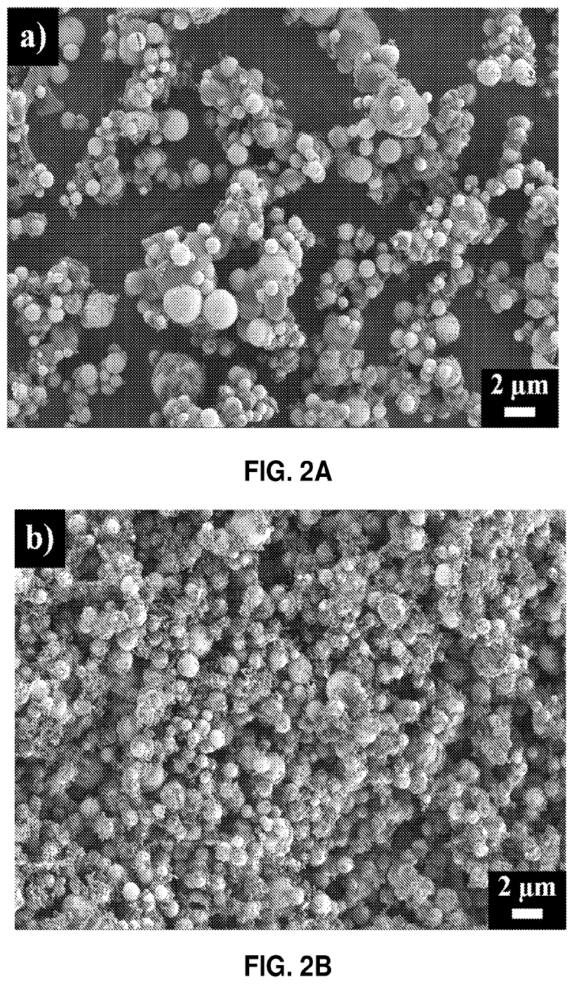

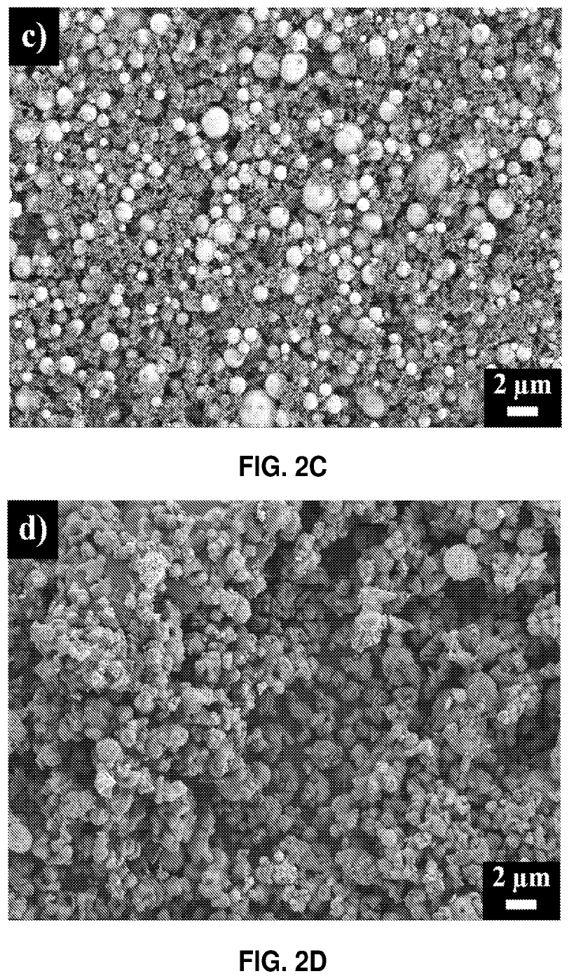

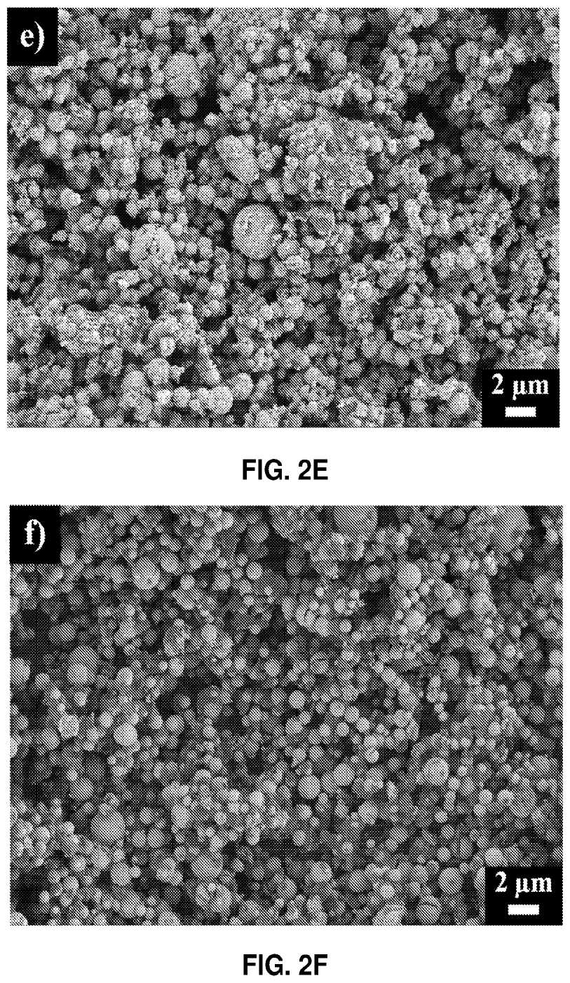

To better understand how various flow rates impact the morphology of FASP-synthesized powders, SEM images of ASP samples were examined and are displayed in FIGS. 2A-2F. In FIG. 2A, it is clear that there are micron-scale, spherical particles and darker areas of material with an undefined structure, in which many of the spherical particles are embedded. After decomposing and grinding the ASP-LFR powders, FIG. 2D shows D-LFR powders that are dominated by dense grains smaller than 1 μm. However, there are some porous, spherical particles distributed throughout the sample that are larger in size compared to the dense grains. FIG. 2B shows that the ASP-MFR powders have micron-scale spherical particles and nano-scale particles that agglomerate together to form clusters and coat the surface of larger particles. From previous experiments, it is clear that these nano-sized particles are composed of lithium compounds and form due the very volatile nature of lithium at high temperatures. After decomposition, FIG. 2E shows that D-MFR powders mainly consist of very porous particles, though some denser aggregates of material can be seen. Finally, ASP-HFR powders shown in FIG. 2C have micron-scale spherical particles surrounded by nano-sized particles, similar to ASP-MFR powders; however, it seems that the smaller nanoparticles form more clusters and coat the surface of larger particles less compared to the ASP-MFR sample. The nanoparticles only form in medium and high flow rate conditions due to the increased temperature of the post-flame zone in the FASP setup as compared to trials with low flow rates. When decomposed, D-HFR powders consist of dark grains distributed amongst micron-sized, porous particles, as shown in FIG. 2F.

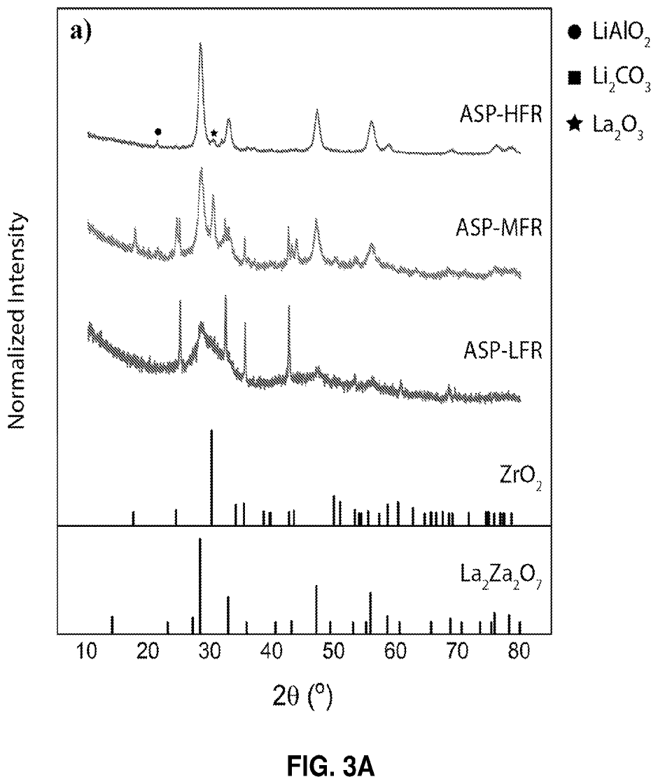

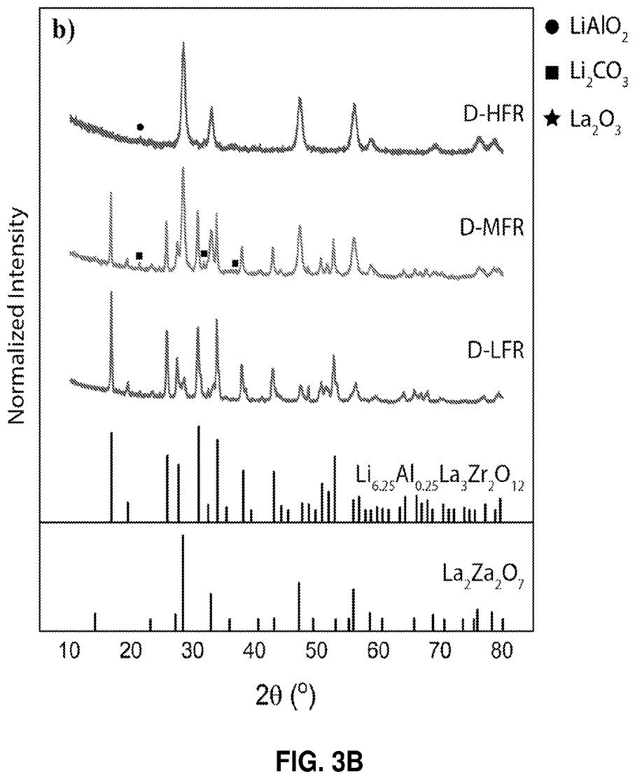

XRD was performed on ASP and decomposed samples to elucidate what phases of material were present, and results are shown in FIGS. 3A and 3B. ASP-LFR consists of some crystallized phases, including ZrO₂ and La₂Zr₂O₇, as well as amorphous material, which is demonstrated by the wide peaks around 20 of 30° in FIG. 3A. As flow rate increases, amorphous content decreases, resulting in fully crystalline ASP-HFR powders. The flame in the medium and high flow rate cases provides enough heat to decompose and react more of the metal nitrates together compared to the low flow rate case, thereby decreasing the amorphous content and increasing the amount of La₂Zr₂O₇. Diffraction patterns for the decomposed samples are shown in FIG. 3B, where the change in low and medium flow rate powders is very clear; both D-LFR and D-MFR powders have the cubic phase of Al-doped LLZO present in the sample. However, further heat treatments would be needed to fully form a well-crystallized Al-doped LLZO sample with minimal impurities. Interestingly, when ASP-HFR powders are decomposed, there is not a significant change in XRD patterns. One proposed explanation is increased lithium volatilization at high flow rates resulting in lithium-deficient powders that prevent cubic Al-LLZO formation.

TGA was employed to determine the mass loss of the samples as a function of temperature, which is important for evaluating their ability to be used for thin-tape SSEs. If tapes shrink significantly during heat treatments, it is likely that they will crack and break upon heat treatment. As shown in FIG. 4, all ASP samples undergo a large weight change from 450° C. to 600° C. as a result of metal nitrates decomposing and a further decrease is seen starting at 700° C. Decomposed samples do not have significant weight change before 700° C., at which point they start to lose about 10% of their weight. Experiencing a smaller weight change will improve the ability of the sample to be used for tape-casting, since the tapes will shrink less during heat treatment, thereby improving their robustness.

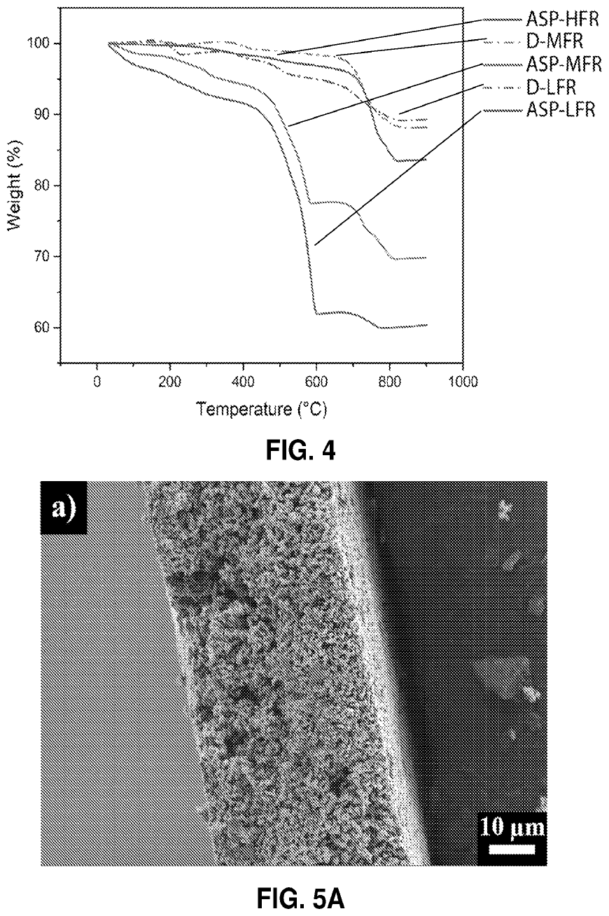

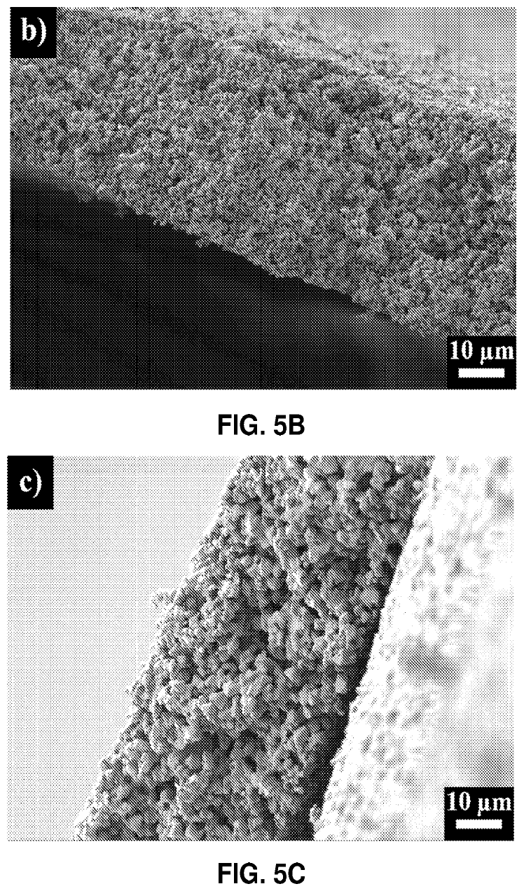

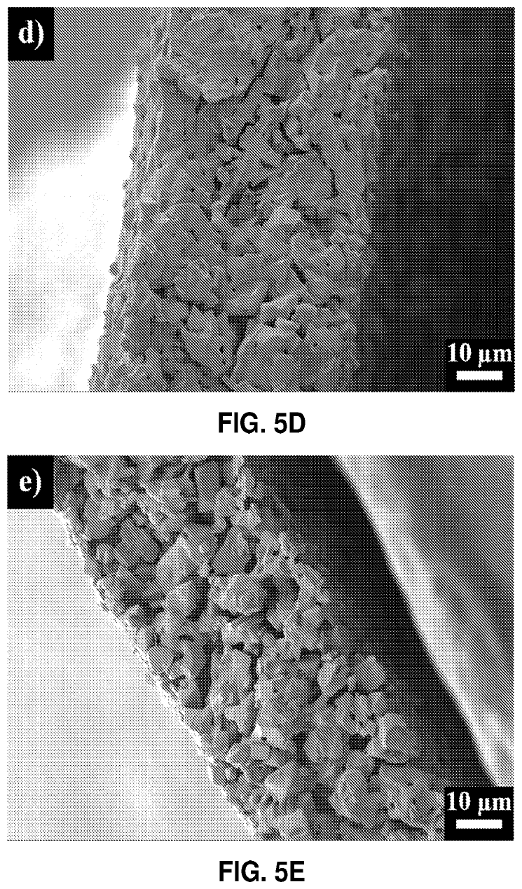

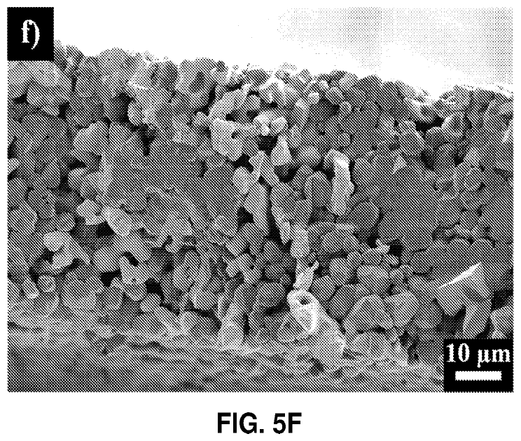

Green tapes synthesized with ASP-LFR and ASP-MFR were extremely inhomogeneous, and a crystal-like material precipitated while the films were drying. It seems that the metal nitrates in the ASP-LFR and ASP-MFR samples could be interacting with the slurry ingredients during the drying process, thereby resulting in low quality green tapes. After sintering the tapes, SEM images were taken of their fractured cross sections, and the results are shown in FIGS. 5A-5F. Tapes made with ASP samples (FIGS. 5A-5C) have smaller grains and are more porous compared to tapes made with decomposed powders (FIGS. 5D-5F). Gases escape when metal nitrates decompose, thereby preventing good densification of tapes made with ASP-LFR and ASP-MFR. In addition, the density of sintered tapes made with decomposed powder seems to decrease as flow rate increases. This could be due to decreased lithium content as flow rate increases due to lithium volatilization at high temperatures. In addition, impurity phases were found in all tapes while taking SEM images, suggesting 1200° C./2 hr causes severe lithium loss in tapes due to their high specific surface area. As elucidated by the XRD results of D-LFR and D-MFR, heat treatments as low as 650° C. show formation of cubic Al-LLZO; therefore, high temperature sintering treatments above 1100° C. typically used in literature can be avoided when employing these powders.

FASP can be used to synthesize Li_{6.25}Al_{0.25}La₃Zr₂O₁₂ SSE thin-tapes. By investigating the effect of flow rate on morphology and crystallinity, it is clear that ASP produced with low and medium flow rate conditions are not suitable for tape casting. However, after a short, low-temperature heat treatment on the ASP, the cubic-phase of Al-LLZO forms and the decomposed powders produce high quality green tapes. Sintering conditions must be optimized to promote good densification without significant impurity formation. High flow rate powders go through significant lithium loss during synthesis, meaning that excess lithium greater than +30 wt % is needed. Therefore, high flow rates should be avoided, since needing such large amounts of excess lithium reduces the scalability of this method. This study has shown that FASP parameters can be tailored to improve ASP suitability for being used in fabricating Al-LLZO thin-tape electrolytes, and future work will investigate increasing the robustness of the SSE tapes.

The method described herein can be used to synthesize oxide-based solid electrolytes for energy storage applications including electric vehicles, consumer electronics, and grid-level energy storage. Furthermore, the battery industry currently uses a commercialized form of tape casting known as roll-to-roll processing, so the method we are proposing integrates well with current battery industry technology.

### BIBLIOGRAPHY

[1] J. Kim, H. Lee, H. Cha, M. Yoon, M. Park, J. Cho. Prospect and Reality of Ni-Rich Cathode for Commercialization. Adv Energy Mater (2018); 8:1702028.
[2] Y. Wang, E. Wang, X. Zhang, H. Yu. High-Voltage “Single-Crystal” Cathode Materials for Lithium-Ion Batteries. Energy & Fuels (2021); 35:1918-32.
[3] J. Langdon, A. Manthiram. A perspective on single-crystal layered oxide cathodes for lithium-ion batteries. Energy Storage Mater (2021);37:143-60.
[4] S. Li, Y. Ren, P. Biswas, S. D. Tse. Flame aerosol synthesis of nanostructured materials and functional devices: Processing, modeling, and diagnostics. Prog Energy Combust Sci (2016);55:1-59.
[5] P. Albertus, S. Babinec, S. Litzelman, A. Newman, Status and challenges in enabling the lithium metal electrode for high-energy and low-cost rechargeable batteries, Nature Energy 3 (2016) 16-21.
[6] M. Balaish, J. C. Gonzalez-Rosillo, K. J. Kim, Y. Zhu, Z. D. Hood, J. L. M. Rupp, Processing thin but robust electrolytes for solid-state batteries, Nature Energy 6 (2021) 227-239.
[7] E. Temeche, S. Indris, R. M. Laine, LiAlO₂/LiAl₅O₈ membranes derived from flame-synthesized nanopowders as a potential electrolyte and coating material for solid-state batteries, ACS Appl. Mater 12 (2020) 46119-46131.
[8] M. Mann, M. Küpers, G. Häuschen, M. Finsterbusch, D. Fattakhova-Rohlfing, O. Guillon, Evaluation of scalable synthesis methods for aluminum-substituted LizLa₃Zr₂O₁₂ solid electrolytes, MDPI 14 (2021) 6809.
[9] P. Badami, S. Smetaczek, A. Limbeck, D. Rettenwander, C. K. Chan, A. N. M. Kannan, Facile synthesis of Al-stabilized lithium garnets by a solution-combustion technique for all solid-state batteries, Mater. Adv. 2 (2021) 5181-5188.

Details of one or more embodiments are set forth in the accompanying drawings and description. Other features, objects, and advantages will be apparent from the description, drawings, and claims. Although a number of embodiments of the invention have been described, it will be understood that various modifications may be made without departing from the spirit and scope of the invention. It should also be understood that the appended drawings are not necessarily to scale, presenting a somewhat simplified representation of various features and basic principles of the invention.

What is claimed is:

1. A method of synthesis of aluminum-doped lithium lanthanum zirconate oxide comprising:
preparing a precursor solution by dissolving lithium nitrate, aluminum nitrate, zirconium (IV) oxynitrate, and lanthanum nitrate in stoichiometric amounts to form an aluminum-doped lithium lanthanum zirconate oxide in water,
aerosolizing the precursor solution in a stream of air using an ultrasonic nebulizer to form droplets;
preheating the droplets;
generating a flame in a burner;
decomposing the droplets by passing through the burner;
depositing as synthesized particles (ASP) on a powder collector; and
heating the ASP in a furnace in the presence of an oxidizing agent to produce the aluminum-doped lithium lanthanum zirconate oxide.

2. The method of claim 1, further comprising adding greater than 10 wt % excess LiNO₃ to the precursor solution.

3. The method of claim 1, further comprising adding greater than 20 wt % excess LiNO₃ to the precursor solution.

4. The method of claim 1, further comprising adding 30 wt % excess LiNO₃ to the precursor solution.

5. The method of claim 1, wherein the aluminum-doped lithium lanthanum zirconate oxide is aluminum-doped Li_{6.25}Al_{0.25}La₃Zr₂O₁₂.

6. The method of any of claims 1-5, wherein the aluminum nitrate of the precursor solution is aluminum nitrate nonahydrate (Al(NO₃)₃·9H₂O).

7. The method of any of claims 1-6, wherein the zirconium (IV) oxynitrate of the precursor solution is zirconium (IV) oxynitrate hydrate (ZrO(NO₃)₂·6H₂O).

8. The method of any of claims 1-7, further comprising maintaining metal salt concentration in the precursor solution at 1 mol/L.

9. The method of any of claims 1-8, wherein the droplets are passed through the co-flow burner at a flow rate of 10 L/min.

10. The method of any of claims 1-9, wherein the powder collector is a glass-fiber filter.

11. The method of any of claims 1-10, wherein the preheating of the aerosolized droplets comprises heating by passage through three low-temperature preheating zones.

12. The method of any of claims 1-11, further comprising maintaining the three preheating zones at 160° C., 170° C., and 190° C., respectively.

13. The method of any of claims 1-12, wherein the mixture of methane and air uses premixed methane and air at 20 L/min and 1.33 L/min, respectively.

14. A method of forming a tape comprising collecting the aluminum-doped lithium lanthanum zirconate oxide;
pressing the ASP;
heating the pressed aluminum-doped lithium lanthanum zirconate oxide in a tube furnace;
cooling the aluminum-doped lithium lanthanum zirconate oxide to room temperature;
grinding the aluminum-doped lithium lanthanum zirconate oxide to an aluminum-doped lithium lanthanum zirconate oxide powder;
preparing a slurry mixture of poly(acrylic) acid, ethanol, the aluminum-doped lithium lanthanum zirconate oxide powder, benzyl butyl phthalate, polyvinyl butyral, and yttria stabilized zirconia milling media;
tape casting the slurry mixture on a polyester substrate;
drying the tape; and
heating the tape.

15. The method of claim 14, further comprising pressing the aluminum-doped lithium lanthanum zirconate oxide at 433 MPa.

16. The method of claim 14, further comprising placing the aluminum-doped lithium lanthanum zirconate oxide in a furnace with oxygen flowing at 0.25 L/min, heating at 5° C./min to 650° C., and holding the aluminum-doped lithium lanthanum zirconate oxide at 650° C. for 3 hours.

17. The method of claim 14, further comprising cooling the tape to room temperature.

18. The method of claim 14, further comprising grinding the aluminum-doped lithium lanthanum zirconate oxide in a mortar and pestle to an aluminum-doped lithium lanthanum zirconate oxide powder.

19. The method of any of claims 14-18, further comprising tape casting the slurry mixture on a polyester substrate with a doctor blade.

20. The method of any of claims 14-19, further comprising drying the tape completely and hot-pressing the dried tape at 500 MPa and 100° C. for 15 minutes.

21. The method of any of claims 14-20, further comprising placing green tapes between alumina substrates in an oxygen atmosphere flowing at 0.25 L/min.

22. The method of any of claims 14-21, further comprising heating tape samples at 5° C./min to 300° C./2 hr.

23. The method of any of claims 1-22, further comprising heating tape samples at 5° C./min to 700° C./2 hr.

24. The method of any of claims 1-23, further comprising heating tape samples at 2° C./min to 1200° C./2 hr.

25. The method of any of claims 1-24, wherein the ultrasonic sprayer is a 1.7 MHz ultrasonic sprayer.

26. A method of synthesis of aluminum-doped lithium lanthanum zirconate oxide comprising:
forming droplets of a precursor solution including a lithium salt, an aluminum salt, a zirconium salt, and a lanthanum nitrate in stoichiometric amounts to form an aluminum-doped lithium lanthanum zirconate oxide in a stream of air;
preheating the droplets;
generating a flame in a burner;
decomposing the droplets by passing through the burner;
depositing as synthesized particles (ASP) on a powder collector; and
heating the ASP in a furnace in the presence of an oxidizing agent to produce the aluminum-doped lithium lanthanum zirconate oxide.

27. The method of claim 26, wherein the lithium salt of the precursor solution is in greater than 10 wt % excess of the stoichiometric amounts to form the aluminum-doped lithium lanthanum zirconate oxide.

28. The method of claim 26, wherein the lithium salt of the precursor solution is in greater than 20 wt % excess of the stoichiometric amounts to form the aluminum-doped lithium lanthanum zirconate oxide.

29. The method of claim 26, wherein the lithium salt of the precursor solution is in greater than 30 wt % excess of the stoichiometric amounts to form the aluminum-doped lithium lanthanum zirconate oxide.

30. The method of claim 26, wherein the aluminum-doped lithium lanthanum zirconate oxide is aluminum-doped Li_{6.25}Al_{0.25}La₃Zr₂O₁₂.

31. The method of claim 26, wherein the droplets are passed through the burner at a flow rate of 5 L/min to 10 L/min.

32. The method of claim 26, wherein the preheating of the droplets comprises passing the droplets through three low-temperature preheating zones.

33. The method of claim 32, further comprising maintaining the three preheating zones at in a temperature gradient of 10° C. to 20° C. between each preheating zone.

34. The method of claim 33, wherein the temperature of the first preheating zone is between 120° C. and 170° C.

35. The method of claim 33, wherein the temperature of the second preheating zone is between 130° C. and 190° C.

36. The method of claim 33, wherein the temperature of the third preheating zone is between 140° C. and 210° C.

37. The method of claim 26, further comprising pressing the ASP prior to heating the ASP in a furnace in the presence of an oxidizing agent to produce the aluminum-doped lithium lanthanum zirconate oxide.

38. The method of claim 37, wherein the pressure is between 200 and 700 MPa.

39. The method of claim 26, wherein the oxidizing agent comprises oxygen or oxygen mixed with an inert gas.

40. The method of claim 26, wherein heating the ASP in a furnace in the presence of an oxidizing agent takes place at a temperature of greater than 650° C.

41. An aluminum-doped lithium lanthanum zirconate oxide comprising fully crystalline cubic aluminum-doped lithium lanthanum zirconate oxide having a grain size of less than 1 micron.

42. A solid state electrolyte comprising an aluminum-doped lithium lanthanum zirconate oxide produced by the method of any one of claims 26-40.

43. A solid state battery comprising the solid state electrolyte of claim 42.
